(19) United States
(12) Patent Application Publication
(10) Pub. No.: US 2025/0209682 A1
(43) Pub. Date: Jun. 26, 2025

(54) IMAGING DEVICE FOR COMPOSITING VIRTUAL IMAGE AND REAL IMAGE, AND CONTROL METHOD OF SAME

(71) Applicant: CANON KABUSHIKI KAISHA, Tokyo (JP)

(72) Inventor: MASAYA HOKAZONO, Kanagawa (JP)

(21) Appl. No.: 18/965,137

(22) Filed: Dec. 2, 2024

(30) Foreign Application Priority Data
Dec. 25, 2023 (JP) 2023-218250

(51) Int. Cl. G06T 11/00; H04N 23/69

(52) U.S. Cl. CPC G06T 11/00; H04N 23/69

(57) ABSTRACT

An imaging device according to the present invention includes: an image sensor configured to capture a real object and output a real image; and one or more processors and/or circuitry configured to execute acquisition processing of acquiring information of a virtual object, execute generating processing of generating a virtual image on a basis of the information of the virtual object acquired in the acquisition processing, and execute compositing processing of compositing the real image and the virtual image to generate a composited image, wherein in the compositing processing, a first composited image in which part of a first real image and the virtual image are composited is generated, and a second composited image in which an image based on a second real image and the first composited image are composited is generated.

### BACKGROUND OF THE INVENTION

### Field of the Invention

The present disclosure relates to an imaging device which is capable of changing an imaging angle of view, and in which a virtual object outside of a shooting angle of view is displayed inside the shooting angle of view.

### Description of the Related Art

In recent years, as one type of augmented reality (AR) technology, development of technology for projecting virtual objects (virtual avatars) in real space has accelerated. There also is conventionally known a shooting system in which an imaging device itself determines shooting conditions and automatically performs shooting, without being given shooting instructions by a person who performs the shooting.

In such shooting systems, pan/tilt/zoom control is generally performed such that a main object to be shot is included within an angle of view of a suitable composition. However, there has been a problem in that in a case in where there are two or more main objects, one of the main objects might be excluded from the screen.

With respect to such a problem, there is conventionally known picture-in-picture (PiP) technology in which information outside of a zoom frame is displayed in a small region within a screen. For example, Japanese Patent Application Publication No. H06-165012 implements a shooting system in which, while performing electronic zoom shooting, the screen prior to zooming is displayed as a small screen in real time, as a picture-in-picture.

However, the imaging system in Japanese Patent Application Publication No. H06-165012 performs picture-in-picture display only on the basis of information within the angle of view of the imaging device, and accordingly cannot display information outside of the angle of view.

### SUMMARY OF THE INVENTION

Accordingly, it is an object of the present disclosure to provide an imaging device that is capable of shooting, at the same time, a plurality of objects, inside and outside of an angle of view, including virtual objects.

The present invention in its first aspect provides an imaging device including: an image sensor configured to capture a real object and output a real image; and one or more processors and/or circuitry configured to execute acquisition processing of acquiring information of a virtual object, execute generating processing of generating a virtual image on a basis of the information of the virtual object acquired in the acquisition processing, and execute compositing processing of compositing the real image and the virtual image to generate a composited image, wherein in the compositing processing, a first composited image in which part of a first real image and the virtual image are composited is generated, and a second composited image in which an image based on a second real image and the first composited image are composited is generated.

The present invention in its second aspect provides a control method of an imaging device including: capturing a real object and outputting a real image, acquiring information of a virtual object, generating a virtual image on a basis of the information of the virtual object, and compositing the real image and the virtual image to generate a composited image, wherein a first composited image in which part of a first real image and the virtual image are composited is generated, and a second composited image in which an image based on a second real image and the first composited image are composited is generated.

Further features of the present invention will become apparent from the following description of exemplary embodiments with reference to the attached drawings.

### BRIEF DESCRIPTION OF THE DRAWINGS

FIG. 1 is a block view illustrating a functional configuration example of an imaging device according to the present disclosure;

FIG. 2A is a diagram schematically illustrating a configuration of the imaging device according to the present disclosure;

FIG. 2B is a diagram for describing a coordinates system of the imaging device according to the present disclosure;

FIG. 3A is a diagram illustrating an example of a shooting scene at a point of starting shooting, according to the present disclosure;

FIG. 3B is a diagram illustrating a composited image in which a real person and a virtual object are in the image, according to the present disclosure;

FIG. 4A is a diagram illustrating a shooting range of an imaging device according to a first embodiment;

FIG. 4B is a diagram for describing a situation in which shooting is performed in the first embodiment;

FIG. 4C is a diagram for describing an image that has been composited in the first embodiment;

FIG. 4D is a diagram representing final recorded video in the first embodiment;

FIG. 5 is a shooting sequence of an automatic control device according to the first embodiment;

FIG. 6A is a diagram for describing a situation in which shooting is performed in a second embodiment;

FIG. 6B is a diagram illustrating a recorded video immediately after starting shooting in the second embodiment;

FIG. 6C is a diagram illustrating a composite image that is generated in the second embodiment; and

FIG. 7 is a shooting sequence of an automatic control device according to the second embodiment.

### DESCRIPTION OF THE EMBODIMENTS

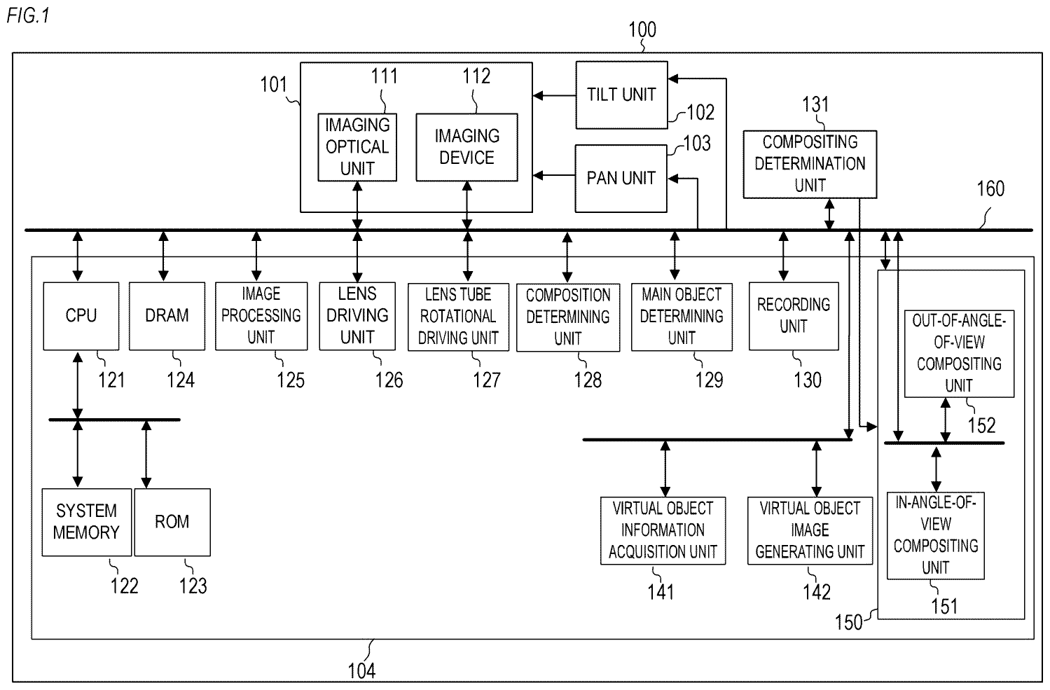

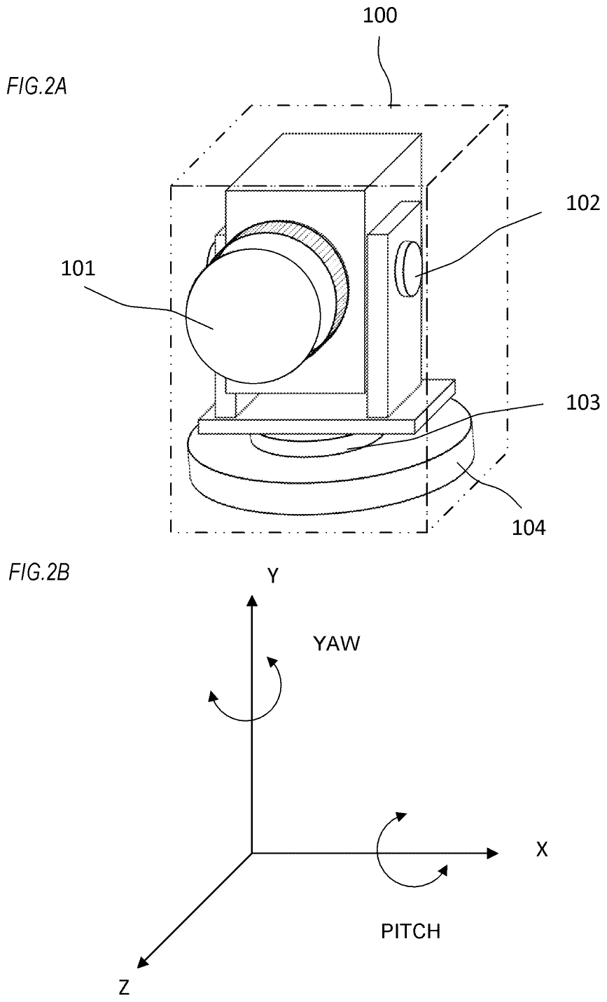

First, description will be made regarding a configuration of an imaging device 100 that is applicable to the present disclosure, with reference to FIGS. 1, 2A, and 2B. Note that while a plurality of embodiments will be described below, all embodiments have FIGS. 1, 2A, and 2B in common.

FIG. 1 is a block diagram illustrating a functional configuration example of the imaging device 100 to which the present disclosure is applicable.

In FIG. 1, a plurality of components are connected to an internal bus 160, and the components are configured so as to be able to exchange data with each other via the internal bus 160.

A lens tube 101 has an imaging optical unit 111 (lens unit) and an imaging device 112.

The imaging optical unit 111 forms optical images on an imaging face of the imaging device 112. The imaging optical unit 111 is made up of movable lenses, such as a variable-magnification lens, a focusing lens, and so forth, and is capable of changing zoom magnification.

The imaging device 112 has, for example, a complementary metal-oxide semiconductor (CMOS) image sensor, and converts an optical image formed on the imaging face by the imaging optical unit 111 into an analog signal group by a photoelectric conversion device. The imaging device 112 then applies analog-to-digital conversion, noise reduction processing, and so forth to the analog signal group, and outputs as video signals. The imaging device 112 corresponds to imaging means performing imaging of a real object and outputting a real image.

The lens tube 101 is rotationally driven by a tilt unit 102 and a pan unit 103. The tilt unit 102 rotationally drives the lens tube 101 about a horizontal axis (pitch direction in FIG. 2B) that is orthogonal to an optical axis of an imaging optical system under instructions from a lens tube rotational driving unit 127. The angle of elevation or the angle of depression of the lens tube 101 (optical axis) is changed by the tilt unit 102. The pan unit 103 rotationally drives the lens tube 101 about a vertical axis (yaw direction in FIG. 2B) that is orthogonal to the optical axis of the imaging optical system under instructions from the lens tube rotational driving unit 127. The azimuthal angle of the lens tube 101 (optical axis) is changed by the pan unit 103.

A central processing unit (CPU) 121 is a main CPU that controls the entirety of the imaging device 100. System memory 122 is made of, for example, random access memory (RAM) (volatile memory using a semiconductor device, or the like). Read-only memory (ROM) 123 stores programs executable by the CPU 121, and various types of settings values of the imaging device 100. The CPU 121 reads programs stored in the ROM 123 into the system memory 122 and executes the programs, thereby controlling actions of the components of the imaging device 100. Dynamic RAM (DRAM) 124 is memory for temporarily storing image data.

An image processing unit 125 objects video signals acquired via the imaging device 112 of the lens tube 101, and image data stored in the DRAM 124, to various types of image processing such as noise reduction processing, color conversion processing, and so forth, under control of the CPU 121.

A lens driving unit 126 drives the imaging optical unit 111 included in the lens tube 101 on the basis of instructions (e.g., target zoom magnification and driving speed) that are input from the CPU 121. The lens driving unit 126 corresponds to angle-of-view driving means for performing driving to change the angle of view of the imaging means by changing the zoom magnification of the imaging optical unit.

The lens tube rotational driving unit 127 drives the tilt unit 102 and the pan unit 103 on the basis of instructions (e.g., target position and driving speed) input from the CPU 121. The lens tube rotational driving unit 127 corresponds to angle-of-view driving means for performing driving to change the orientation of the angle of view of the imaging means vertically and horizontally.

A composition determining unit 128 calculates driving amounts for lens driving and lens tube rotational driving in order to match the shooting angle of view with a main object, and outputs each to the CPU 121. Also, in a case of compositing images, the composition determining unit 128 calculates a placement region at which to place an image to be composited on an image to be subjected to compositing (e.g., placement coordinates and placement area), and outputs to the CPU 121.

A main object determining unit 129 determines whether or not objects that are included in a real image generated by the image processing unit 125, and virtual objects regarding which information is acquired by a virtual object information acquisition unit 141, are main objects. Determination of whether main objects or not can be performed using known technology, such as, for example, facial recognition technology, voice recognition technology, and so forth. In the present embodiment, the term “main object” refers to an object that should be included in the shooting angle of view with a suitable composition.

A recording unit 130 includes recording media such as, for example, a memory card, a compact disc (CD), a digital versatile disc (DVD), and so forth. The recording unit 130 records images generated by the image processing unit 125 and images composited by an image compositing unit 150.

A compositing determination unit 131 determines how real images and virtual images should be composited. Determination is performed on the basis of whether or not a plurality of main objects can be included within the same angle of view. In a case in which the plurality of main objects cannot be included within the same angle of view, the compositing determination unit 131 determines to composite composited image data of a main object that is a virtual object upon a real image including a main object that is a real object, by picture-in-picture (PiP) format, using an out-of-angle-of-view compositing unit 152.

The image compositing unit 150 performs compositing of the real images and virtual images to generate composited images. More specifically, the image compositing unit 150 generates composited image data in which image data generated by an in-angle-of-view compositing unit 151 and image data generated by the out-of-angle-of-view compositing unit 152 are composited, on the basis of instructions input from the CPU 121.

The in-angle-of-view compositing unit 151 generates composited image data of image data generated by the image processing unit 125 (second real image) and image data generated by a virtual object image generating unit 142 with respect to a virtual object in the shooting angle of view.

The out-of-angle-of-view compositing unit 152 generates composited image data of image data that the virtual object image generating unit 142 generates with respect to virtual objects outside of the shooting angle of view (first real image), and real images that are outside of the angle of view. The out-of-angle-of-view compositing unit 152 has a storage unit that is omitted from illustration, and stores image data necessary for compositing.

The virtual object information acquisition unit 141 externally acquires virtual object information including position information, distance information, and display form relating to virtual objects. Virtual objects are three-dimensional model images situated in virtual space that are projected onto real space.

The virtual object image generating unit 142 generates image data in which a three-dimensional image of a virtual object as viewed from the imaging device 100 is two-dimensionally projected, on the basis of information of the virtual object acquired by the virtual object information acquisition unit 141. Hereinafter, an image that the virtual object image generating unit 142 generates on the basis of information of a virtual object is also referred to as a “virtual image”.

FIG. 2A is a diagram schematically illustrating the configuration of the imaging device according to the present disclosure, and configurations that are the same as those in FIG. 1 are denoted by the same signs.

The lens tube 101 is attached to the tilt unit 102. The tilt unit 102 is attached to the pan unit 103. The lens tube 101 (optical axis) attached to the tilt unit 102 is rotationally driven by the pan unit 103 rotationally driving the tilt unit 102.

FIG. 2B illustrates an orthogonal coordinates system, in which the optical axis of the imaging optical system is a Z axis, and an intersection of the imaging device and the optical axis is the point of origin. The tilt unit 102 is rotationally driven about an X axis (pitch direction), and the pan unit 103 about a Y axis (yaw direction).

Two embodiments will be described below. In a first embodiment, composited display recording of a virtual object is performed on the basis of whether the virtual object is inside or outside of the angle of view of the imaging device, as determination criterion. In a second embodiment, composited display recording of a virtual object is performed on the basis of determination by the compositing determination unit as the criterion.

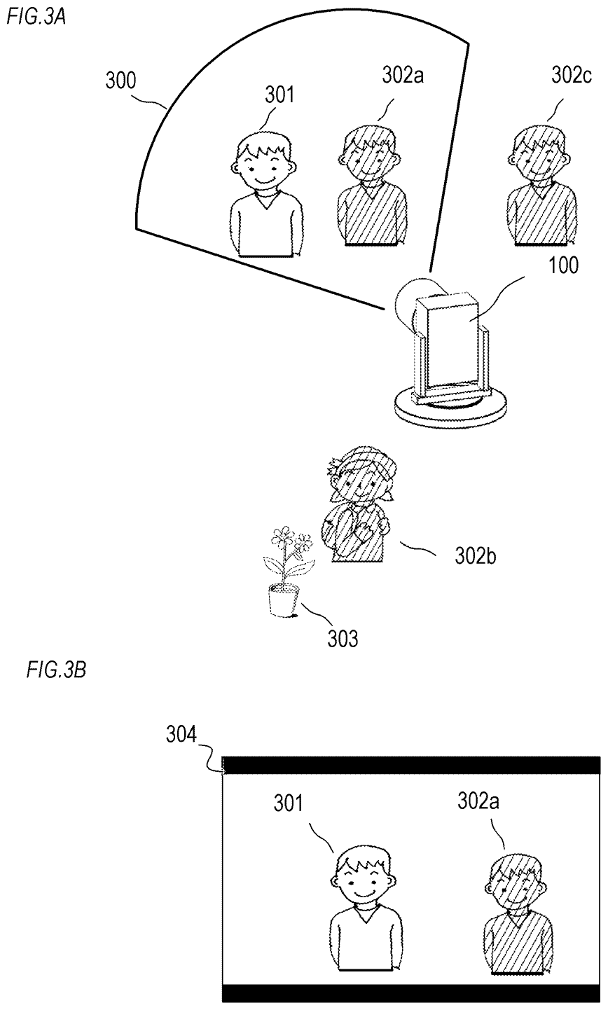

FIGS. 3A and 3B are diagrams for describing a situation in which shooting is performed by the imaging device 100. In the description of the first embodiment and the second embodiment, description will be made using the situation in FIGS. 3A and 3B as an example. FIG. 3A illustrates a situation of the point in time of starting shooting, in a scene of performing shooting of a moving image, as an example of automatic shooting of a table game, recording minutes in a business meeting, or the like. In the example in FIG. 3A, there is a real person 301, and virtual objects 302a to 302c (people displayed in a virtual manner) in the vicinity around the imaging device 100. Also, there is a real object 303 in a background of the virtual object 302b. FIG. 3B is a diagram representing a composited image 304 in which there are the real person 301 and the virtual object 302a positioned in an angle of view 300 of the imaging device 100.

### First Embodiment

The first embodiment of the present disclosure will be described.

In the present embodiment, an example will be described in which, in a case in which a plurality of main objects including a virtual object cannot be included in the angle of view at the same time even when the lens of the imaging device 100 is set to the widest angle, the plurality of main objects are shot and recorded at the same time, by performing a composited display of virtual objects outside of the angle of view.

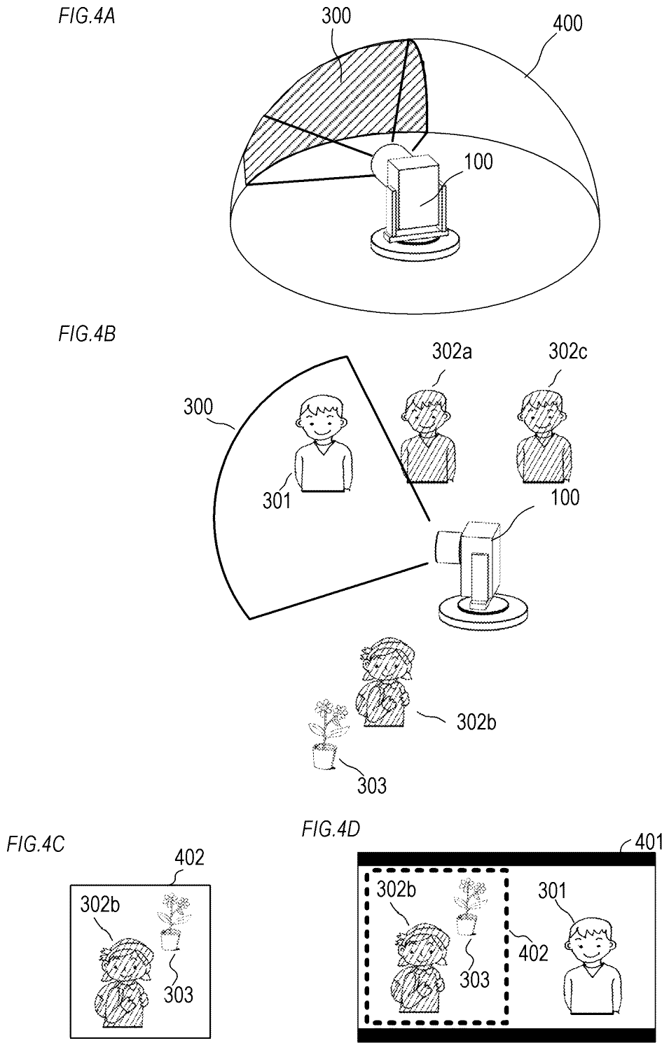

FIGS. 4A to 4D are diagrams for conceptually describing the present embodiment. FIG. 4A is a diagram illustrating a shooting range of the imaging device 100, FIG. 4B is a diagram for describing a situation in which shooting is performed, FIG. 4C is a diagram for describing an image in which a virtual object outside of the angle of view and a real image of the background are composited, and FIG. 4D is a diagram representing final recorded video. In the present embodiment, an example is given in which the real person 301 and the virtual object 302b are determined to be main objects, and the imaging device 100 performs automatic angle-of-view control to include these two main objects in the angle of view.

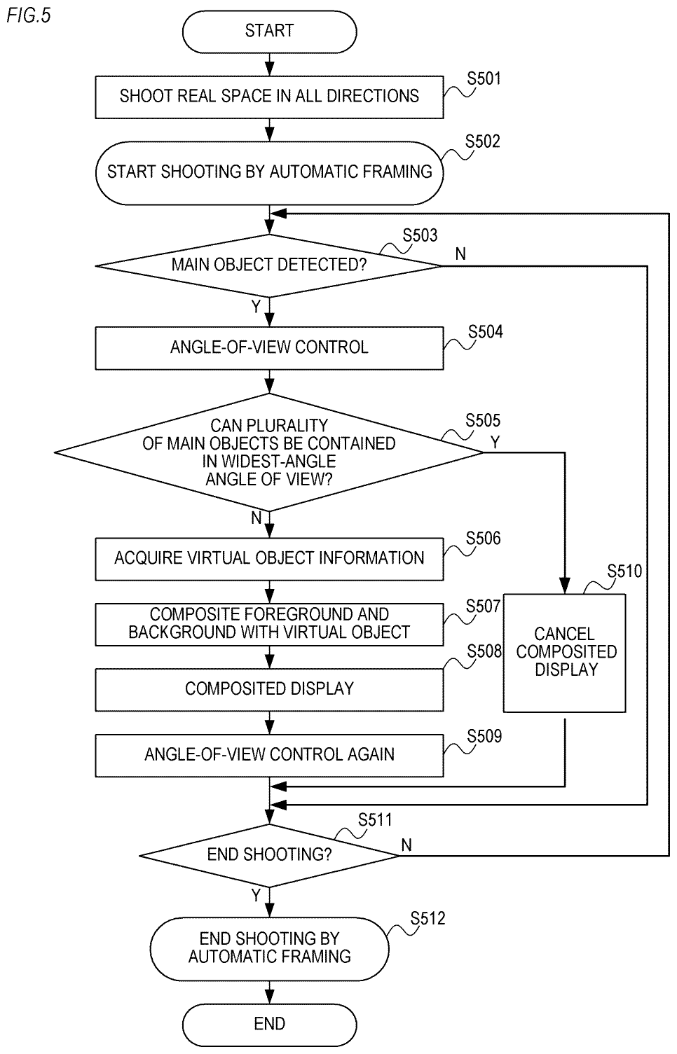

FIG. 5 is a flowchart of automatic control processing in the present embodiment. Each operation in the processing of this flowchart is realized by the CPU 121 loading a program stored in the ROM 123 to the system memory 122 and executing the program.

In S501, the CPU 121 causes the lens driving unit 126 to perform optical zoom control and the lens tube rotational driving unit 127 to perform pan/tilt rotational driving control, so as to shoot real objects in a full range 400 of which the imaging device 100 is capable of shooting (FIG. 4A). Note that while the full range 400 is illustrated as being a hemispherical range in FIG. 4A, the full range 400 may be a range of any shape, such as a full sphere or the like. The CPU 121 stores, in the image compositing unit 150, images data of the full range 400 that is shot.

In S502, the imaging device 100 starts shooting by automatic framing. Assumption will be made that the objects are situated as illustrated in FIG. 3A at the point in time of starting shooting. In S502, the CPU 121 causes the in-angle-of-view compositing unit 151 to generate the composited image 304 that the real person 301 and the virtual object 302a are in, on the basis of data acquired by the virtual object information acquisition unit 141 and the virtual object image generating unit 142 (FIG. 3B). The virtual object information acquisition unit 141 externally acquires information (position information, display information) regarding the virtual object 302a that is within the angle of view 300 of the imaging device 100. The virtual object image generating unit 142 generates image data of the virtual object 302a on the basis of the information that the virtual object information acquisition unit 141 acquires. The in-angle-of-view compositing unit 151 generates the composited image 304 by compositing image data of real space including the real person 301 within the angle of view 300, generated by the image processing unit 125, and the image data generated by the virtual object image generating unit 142. In S502, the CPU 121 causes the recording unit 130 to start recording the recorded video.

In S503, the CPU 121 determines whether or not the main object determining unit 129 has detected a main object. In a case of having detected a main object, the flow advances to S504, and otherwise, the flow advances to S511. Known techniques can be used as the main object detection method performed by the main object determining unit 129. For example, detection of particular people in the angle of view by facial detection, detection using voice information of people talking outside of the angle of view, and so forth, can be employed. In the present embodiment, the real person 301 and the virtual object 302b are detected as main objects.

In S504, the CPU 121 causes the composition determining unit 128 to calculate angle-of-view driving amounts, and causes the lens driving unit 126 to perform optical zoom control and the lens tube rotational driving unit 127 to perform pan/tilt rotational driving control, on the basis of the angle-of-view driving amounts (FIG. 4B). The composition determining unit 128 calculates the angle-of-view driving amounts such that all main objects are included within the angle of view 300 of the imaging device 100, giving priority to real objects over virtual objects among the main objects.

In S505, the CPU 121 determines whether or not the plurality of objects determined to be main objects in S503 can be included within the angle of view at the same time, in a case in which the optical zooming of the imaging device 100 is set to the widest angle (wide-angle end angle of view). In other words, the CPU 121 determines whether or not an angle of view in which all main objects can be included at the same time is within the widest angle. In a case of determining that in which not all main objects can be included at the same time, the flow advances to S506, and otherwise, advances to S510.

The determination technique of S505 will be described. The virtual object information acquisition unit 141 acquires angle information θr-p (azimuthal angle) and θr-v (elevation/depression angle) of the virtual object 302b determined to be a main object in S503, with respect to the imaging device 100. Also, the imaging device 100 can calculate the angle information θv-p (azimuthal angle) and θv-v (elevation/depression angle) of the real person 301 from the imaging device 100.

The determination of S505 can be performed using the following Expressions at this time.

$$\begin{matrix}[ Math . 1 ] & \\ \vert {θ}_{c - p} - {θ}_{s - p} \vert < \vert {θ}_{v - p} - {θ}_{r - p} \vert < \vert {θ}_{c - p} + {θ}_{s - p} \vert & ( Expression 1 a )\end{matrix}$$

$$\vert {θ}_{c - v} - {θ}_{s - v} \vert < \vert {θ}_{v - v} - {θ}_{r - v} \vert < \vert {θ}_{c - v} + {θ}_{s - v} \vert \qquad ( Expression 1 b )$$

Here, θc-p and θc-v are the angles in azimuthal direction and vertical direction of the lens tube 101 calculated by the composition determining unit 128 in S504. Also, θs-p and θs-v are the angles in the azimuthal direction and vertical direction from the center to the end of the angle of view, at the wide-angle end of the lens tube 101.

When neither Expression 1a nor Expression 1b holds, the CPU 121 determines that the real person 301 and the virtual object 302b cannot be included in the widest-angle angle of view at the same time. Note however, one of Expression 1a or Expression 1b not holding may be used as a condition for determination.

Note that while a determination method has been described here regarding a case in which the number of main objects is two, determination can be performed in a case in which the number of main objects is three or more, in the same way. For example, determination based on the above-described Expressions may be performed regarding any two main objects, or determination based on the above-described Expressions may be performed regarding two main objects that are at farthest angles away from each other.

Processing of S506 and thereafter is processing executed when determination is made in S505 that the main objects cannot be included in the widest-angle angle of view at the same time.

In S506, the CPU 121 causes the virtual object information acquisition unit 141 to acquire distance information and display form information for displaying the virtual object 302b, and causes the virtual object image generating unit 142 to generate image data for the virtual object 302b on the basis of the information that is acquired.

In S507, compositing of the image data of the virtual object 302b and the real image of the vicinity of the position of the virtual object 302b is performed. Specifically, in S507, the CPU 121 causes the out-of-angle-of-view compositing unit 152 to perform compositing of the image data of the virtual object 302b generated in S506 and the image data stored in S502, on the basis of the information of the virtual object information acquisition unit 141. The virtual object information acquisition unit 141 outputs distance information and angle information of the virtual object 302b to the out-of-angle-of-view compositing unit 152. The out-of-angle-of-view compositing unit 152 extracts vicinity data of the vicinity of the virtual object 302b, from the image data stored in S502, on the basis of the information of the virtual object 302b input from the virtual object information acquisition unit 141. The out-of-angle-of-view compositing unit 152 generates image data including the background and foreground of real objects in the vicinity of the virtual object 302b, by compositing the vicinity image data that is extracted and the virtual object 302b. The processing of S507 can be comprehended as processing of generating a first composited image in which part of a first real image obtained by performing imaging the entirety of a range that the imaging device 100 is capable of imaging, and a virtual image of a virtual object, are composited. In the example in FIGS. 4A to 4D, a composited image 402 is generated in which the real object 303 and the virtual object 302b are composited (FIG. 4C).

In S508, the CPU 121 causes the image compositing unit 150 to generate a composited image 401 in which an image based on the real image in which the angle of view 300 is shot, and the composited image 402 generated in S507 by the out-of-angle-of-view compositing unit, are further composited. The image based on the real image in which the angle of view 300 is shot may be this real image itself, or may be a composited image in which the in-angle-of-view compositing unit 151 has composited a virtual image with this real image. The processing of S508 can be comprehended as being processing of compositing an image based on a second real image including the real person 301 that is a main object, and a first composited image, so as to generate a second composited image.

In S508, the CPU 121 performs image adjustment such that the main object 301 (first object) can be image-captured with a suitable composition. Specifically, the CPU 121 causes the composition determining unit 128 to calculate the angle-of-view driving amounts, and causes the lens driving unit 126 to perform optical zoom control and the lens tube rotational driving unit 127 to perform pan/tilt rotational driving control, on the basis of these angle-of-view driving amounts that are calculated (FIG. 4B). The composition determining unit 128 calculates the angle-of-view driving amounts such that the main object 301 can be shot with a suitable composition in a margin region other than the region in which the composited image 402 within the composited image 401 is composited. The CPU 121 performs control such that image capturing is performed following the angle of view adjustment, and composites the first composited image with the real image that is obtained (second real image).

In a case of having caused the image compositing unit 150 to generate a composited image in S508, in S509 the CPU 121 causes the image compositing unit 150 to cancel the compositing of images. After cancelling the compositing, the image compositing unit 150 generates composited image data at the in-angle-of-view compositing unit 151 (FIG. 4D).

S510 is processing that is executed in a case in which determination is made in S505 that the main objects can be included in the same angle of view. In a case of having caused the image compositing unit 150 to generate a composited image in S508, in S510 the CPU 121 causes the image compositing unit 150 to cancel the compositing of images. After cancelling the compositing, the image compositing unit 150 generates composited image data at the in-angle-of-view compositing unit 151.

In S511, the CPU 121 determines whether or not the imaging device 100 has received an operation to stop shooting. In a case of having received an operation to end shooting, the flow advances to S512, and the shooting and recording by the imaging device 100 is stopped and this flow ends. Otherwise, the flow advances to S503.

As described above, according to the present embodiment, main objects that are real people within the angle of view can be retained as recorded video, and also main objects that are virtual objects that are outside of the angle of view can be composited and retained as recorded video at the same time. Also, imparting the virtual objects outside of the angle of view with real foreground and background enables unnatural recorded video, in which only the virtual object is composited, to be circumvented.

### Second Embodiment

The second embodiment of the present disclosure will be described.

In the present embodiment, in a case in which a suitable composition is not achieved even through the main objects including virtual objects can be included in the angle of view at the same time, the plurality of main objects are shot and recorded at the same time by performing composited display according to the picture-in-picture format.

The present embodiment differs from the first embodiment with respect to the point that composited display of virtual objects is performed on the basis of the determination criterion of the compositing determination unit 131, even in a case in which the main objects can be included in the wide-angle end angle of view of the imaging device 100.

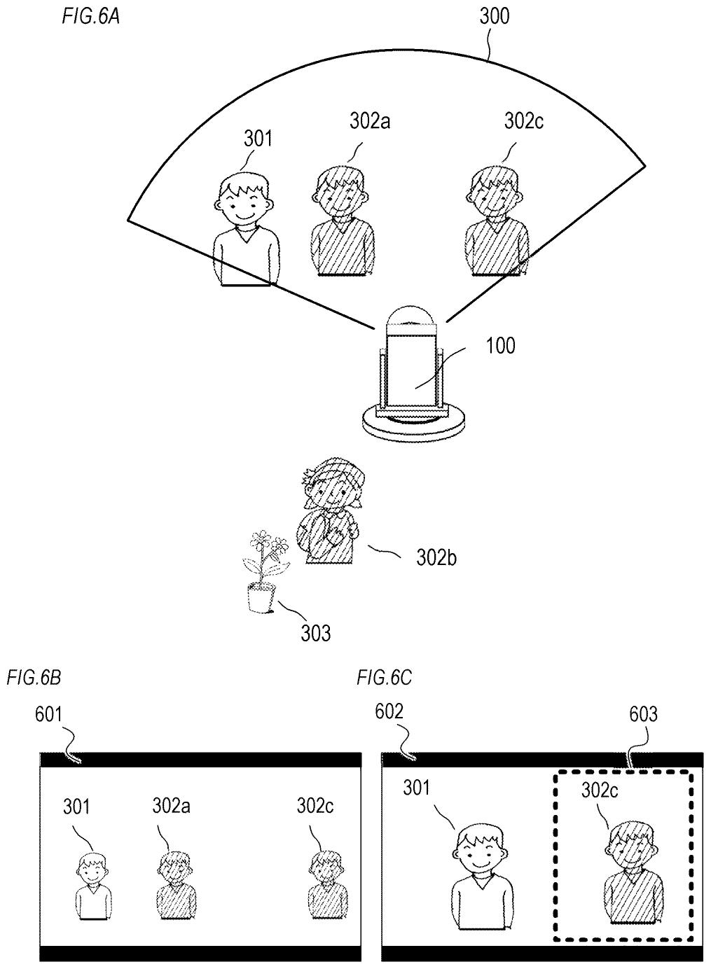

FIGS. 6A to 6C are diagrams for conceptually describing the present embodiment. In the present embodiment, an example is described in which the real person 301 and the virtual object 302c are determined to be main objects, and the imaging device 100 is performing automatic angle-of-view control such that these two main objects can be included within the angle of view. FIG. 6B illustrates a recorded video 601 of the imaging device 100 immediately following starting of shooting.

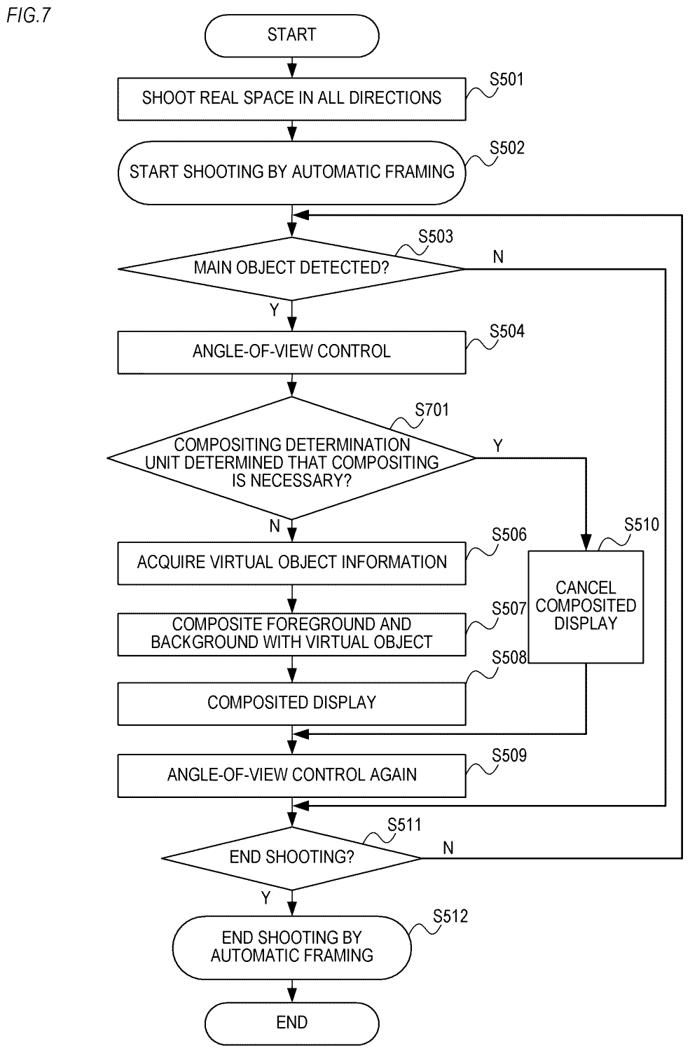

FIG. 7 is a flowchart of automatic control processing in the present embodiment. Each sequence in the processing of this flowchart is realized by the CPU 121 loading a program stored in the ROM 123 to the system memory 122 and executing the program.

Note that sequences S501 to S511 in FIG. 7 are the same as those in FIG. 5 described in the first embodiment, and accordingly description thereof will be omitted. Sequence S701 that differs from the first embodiment will be described.

Note that in S509, the real person 301 and the virtual object 302c that are determined to be main objects are each shot at a suitable shooting angle of view, and a composited image 602 is generated (FIG. 6C).

In S701, the CPU 121 causes the compositing determination unit 131 to determine whether or not compositing of the image data of the in-angle-of-view compositing unit 151 and the image data of the out-of-angle-of-view compositing unit 152 by the image compositing unit 150 in S508 is necessary. In a case of making determination that this is necessary, the flow advances to S506, and otherwise to S510.

In S701, the compositing determination unit 131 determines, in addition to whether or not the main objects can be included in the same angle of view, whether or not to perform compositing, in accordance with whether or not a suitable composition will be achieved in a case in which the main objects are included in the same angle of view. Determination of whether or not the main objects can be included in the same angle of view is the same as in the first embodiment, and accordingly description will be omitted. Determination of whether or not a suitable composition will be achieved in a case in which the main objects are included in the same angle of view will be described below. The compositing determination unit 131 determines, for example, whether or not the sizes occupied by the main objects in the recorded video 601 will be suitable in a case in which the main objects are included in the same angle of view. Specifically, the compositing determination unit 131 may make this determination using the optical zoom magnification of the lens tube 101. The compositing determination unit 131 determines that image compositing is necessary in a case in which the optical zoom magnification is smaller than a first threshold value (case of wide angle) in order to include the main objects in the same angle of view. The optical zoom magnification following optical zoom control being performed by the lens driving unit 126 in S504 can be used for the optical zoom magnification to include the main objects in the same angle of view.

Note that instead of performing the determination of S701 on the basis of the zoom magnification, angle-of-view occupancy proportion of the main objects occupying in the recorded video 601 may be used as a determination criterion. That is to say, determination that image compositing is necessary may be made in a case in which the angle-of-view occupancy proportion of either one of the main objects in the image-captured image, in a case in which the main objects are included in the same angle of view, is smaller than a second threshold value. Note that determination that image compositing is necessary may be made in a case in which the angle-of-view occupancy proportion of all of the main objects is smaller than the second threshold value, or in a case in which the angle-of-view occupancy proportion of a particular main object (e.g., a main object, a real object, or the like, with a high degree of importance) is smaller than the second threshold value.

Also, the determination criterion in S701 may be based on position information of the main objects. For example, the compositing determination unit 131 may determine that image compositing is necessary in a case in which a distance between main objects is greater than a third threshold value.

As described above, according to the present embodiment, a situation of an unsuitable composition, such as a case in which the main objects are included in the wide-angle end angle of view of the imaging device 100 but the main objects are small in the image, or the like, can be circumvented. Also, in a case of performing automatic angle-of-view control of a plurality of main objects, a situation in which shooting one main object with a suitable composition results in an unsuitable shooting angle of view for the other main objects can be circumvented.

According to the present disclosure, a plurality of main objects, including virtual objects, can be suitably shot at the same time.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-218250, filed on Dec. 25, 2023, which is hereby incorporated by reference herein in its entirety.

What is claimed is:

1. An imaging device comprising:
an image sensor configured to capture a real object and output a real image; and
one or more processors and/or circuitry configured to
execute acquisition processing of acquiring information of a virtual object,
execute generating processing of generating a virtual image on a basis of the information of the virtual object acquired in the acquisition processing, and
execute compositing processing of compositing the real image and the virtual image to generate a composited image, wherein
in the compositing processing, a first composited image in which part of a first real image and the virtual image are composited is generated, and a second composited image in which an image based on a second real image and the first composited image are composited is generated.

2. The imaging device according to claim 1, wherein
the second real image is a real image including a main object, and
the first real image is a real image in which a range that differs from a range of the second real image is captured.

3. The imaging device according to claim 2, wherein
the first real image is a real image in which an entirety of a range that the imaging device is capable of capturing is captured.

4. The imaging device according to claim 1, wherein
the image based on the second real image is the second real image.

5. The imaging device according to claim 1, wherein
the image based on the second real image is an image in which a virtual image of a second virtual object is composited with the second real image.

6. The imaging device according to claim 1, wherein
in a case in which a first object and a second object is not capable of including in a same angle of view, the one or more processors and/or circuitry further execute compositing determination processing of determining that the second composited image is generated in the compositing processing.

7. The imaging device according to claim 6, wherein
the first object is a first object included in the second real image, and
the second object is the virtual object.

8. The imaging device according to claim 6, wherein
the one or more processors and/or circuitry further execute main object determination processing of determining whether or not an object included in the real image, and the virtual object regarding which the information is acquired in the acquisition processing, are main objects, wherein
the first object and the second object are objects determined to be main objects in the main object determination processing.

9. The imaging device according to claim 6, wherein
the one or more processors and/or circuitry further execute driving processing of performing driving to change an angle of view of the image sensor,
in a case where it is determined that the second composited image is generated in the compositing determination processing, the angle of view is adjusted in the driving processing such that capturing is capable of performing with a composition determined on a basis of the first object, and
the image sensor performs capturing of the second real image after adjustment of the angle of view.

10. The imaging device according to claim 9, wherein
in the driving processing, the composition is determined such that the first object is captured in a region other than a region in which the first composited image is composited.

11. The imaging device according to claim 9, wherein
in the driving processing, an orientation of the angle of view of the image sensor performing capturing is changed vertically and horizontally.

12. The imaging device according to claim 9, further comprising:
an optical system that is capable of changing a zoom magnification, wherein
in the driving processing, the angle of view is changed by changing of the zoom magnification of the optical system.

13. The imaging device according to claim 1, wherein,
in a case where a zoom magnification of capturing becomes smaller than a first threshold value in order to include a first object and a second object in a same angle of view, the one or more processors and/or circuitry further execute compositing determination processing of determining that the second composited image is generated in the compositing processing.

14. The imaging device according to claim 1, wherein,
in a case where including a first object and a second object in a same angle of view causes an occupancy proportion of the first object or the second object in a captured image to be smaller than a second threshold value, the one or more processors and/or circuitry further execute compositing determination processing of determining that the second composited image is generated in the compositing processing.

15. The imaging device according to claim 1, wherein,
in a case in which a distance between a first object and a second object is greater than a third threshold value, the one or more processors and/or circuitry further execute compositing determination processing of determining that the second composited image be generated in the compositing processing.

16. The imaging device according to claim 1, wherein
the one or more processors and/or circuitry further execute recording processing of recording in a recording medium the composited image that is composited in the compositing processing.

17. A control method of an imaging device comprising:
capturing a real object and outputting a real image,
acquiring information of a virtual object,
generating a virtual image on a basis of the information of the virtual object, and
compositing the real image and the virtual image to generate a composited image, wherein
a first composited image in which part of a first real image and the virtual image are composited is generated, and a second composited image in which an image based on a second real image and the first composited image are composited is generated.

18. A non-transitory computer readable medium that stores a program, wherein the program causes a computer to execute a control method of an imaging device, the control method comprising:
capturing a real object and outputting a real image,
acquiring information of a virtual object,
generating a virtual image on a basis of the information of the virtual object, and
compositing the real image and the virtual image to generate a composited image, wherein
a first composited image in which part of a first real image and the virtual image are composited is generated, and a second composited image in which an image based on a second real image and the first composited image are composited is generated.
